(19) United States
(12) Patent Application Publication
(10) Pub. No.: US 2024/0161352 A1
(43) Pub. Date: May 16, 2024

(54) Method and System for Creating a Textile Pattern Design Using an Image Generating Learning Algorithm

(71) Applicant: AIMADETHIS LLC, Buffalo, NY (US)

(72) Inventor: Yasmeen Collins, Brooklyn, NY (US)

(21) Appl. No.: 18/055,343

(22) Filed: Nov. 14, 2022

(51) Int. Cl. G06T 11/00; G05B 13/02; G06N 3/045

(52) U.S. Cl. CPC G06T 11/001; G05B 13/027; G06N 3/045

(57) ABSTRACT

A method and system for creating a textile pattern design. Initially, curating a dataset of images happens. Next, the dataset of images is imported into an image generating learning algorithm. The image generating learning algorithm can be any applicable machine learning algorithm including GANs, CNNS, and so on. The image generating learning algorithm is then run and can be interrupted if necessary. Whether interrupted or not, the running of the image learning algorithm results in receiving an output. The output may need to be edited to be a continuous image, so either an edited or unedited output is then duplicated onto a continuous sheet of fabric. The continuous sheet of fabric is used for any clothing, curtains, apparel, and other textile creations.

### BACKGROUND

Machine learning (ML) is often viewed as a subdivision of artificial intelligence (AI). ML programs are designed as decision-making programs and are often used to improve computer system operations, create mathematical models, and much more. However, AI and ML are complicated areas of development. A growing field is using AI and ML along with human input to create textile pattern designs. The human mind does not process image creation in the same way as AI and ML. While human creativity can generate various ideas and creations, human creativity is also unclear. On the other hand, AI and ML can be primed with a specific dataset in a controlled and predictable manner to build off or work with human creativity.

### SUMMARY

What is presented is a method for creating a textile pattern design using AI and printing it on fabric and creating apparel from the fabric. The method begins by curating a dataset of images. The dataset of images is then imported into an image generating learning algorithm. The dataset of images can be normalized or not prior to being imported into the image generating learning algorithm. The image generating learning algorithm can be any applicable ML algorithm such as general adversarial networks (GANs), convolutional neural networking (CNNs), and other similar ML algorithms. The image generating learning algorithm is then run to produce an output. The output is received and then duplicated onto a continuous sheet of fabric. The output from the image generating learning algorithm may be edited prior to duplicating the output to enable the duplicated output to be a continuous image on a continuous sheet of fabric. The continuous sheet of fabric is used for any clothing, curtains, apparel, and other textile creations.

In some instances, the running of the image generating learning algorithm can be interrupted to receive an intermediate output from the image generating learning algorithm. The intermediate output may need to be edited to ensure the intermediate output can be a continuous image. Regardless of editing the intermediate output, the intermediate output is duplicated onto a continuous sheet of fabric. The continuous sheet of fabric is used for any clothing, curtains, apparel, and other textile creations.

What is also presented is a system for creating a textile pattern design using AI and printing it on fabric and creating apparel from the fabric. The system begins with curating a dataset of images. The dataset of images is then imported into an image generating learning algorithm. The dataset of images can be normalized or not prior to being imported into the image generating learning algorithm. The image generating learning algorithm can be any applicable ML algorithm such as GANs, CNNs, and other similar ML algorithms. The image generating learning algorithm is then run to produce an output. The output is received and then duplicated onto a continuous sheet of fabric. The output from the image generating learning algorithm may be edited prior to duplicating the output to enable the duplicated output to be a continuous image on a continuous sheet of fabric. The continuous sheet of fabric is used for any clothing, curtains, apparel, and other textile creations.

In some instances, the running of the image generating learning algorithm can be interrupted to receive an intermediate output from the image generating learning algorithm. The intermediate output may need to be edited to ensure the intermediate output can be a continuous image. Regardless of editing the intermediate output, the intermediate output is duplicated onto a continuous sheet of fabric. The continuous sheet of fabric is used for any clothing, curtains, apparel, and other textile creations.

The features, functions, and advantages of the present invention can be achieved independently in various embodiments of the present inventions or may be combined in yet other embodiments. Although specific features, structures, embodiments, methods, objectives, benefits, advantages, functionality, and applications may have been disclosed, it will be understood by those having skill in the art that changes, including but not limited to, variations, modifications, combinations, alterations, omissions, and various other applications, will occur to those of ordinary skill in the art and such changes will be made without departing from the spirit and the scope of the invention as claimed. It should also be understood by anyone who reads this document that the terminology and phraseology used herein are for the purpose of description and should not be considered limiting.

### BRIEF DESCRIPTION OF DRAWINGS

The features and the inventive aspects of the present invention will become more apparent upon reading the following detailed description, and drawings, of which the following is a brief description:

FIG. 1 illustrates a flowchart showing the general method and system disclosed herein.

FIG. 2 illustrates a more detailed flowchart of the method and system of FIG. 1.

FIG. 3 illustrates a flowchart of the method and system disclosed herein using GAN as the image learning algorithm.

FIG. 4 illustrates an unedited image which is output from the method and system of FIG. 1.

FIG. 5 illustrates the image of FIG. 4 repeated six times to be duplicated on a continuous sheet of fabric.

FIG. 6 illustrates the image of FIG. 5 as a top piece of apparel worn by a person.

### DETAILED DESCRIPTION OF THE INVENTION

Referring to the drawings, some of the reference numerals are used to designate the same or corresponding parts through several of the embodiments and figures shown and described. Variations of corresponding parts in form or function that are depicted in the figures are described. It will be understood that variations in the embodiments can generally be interchanged without deviating from the invention.

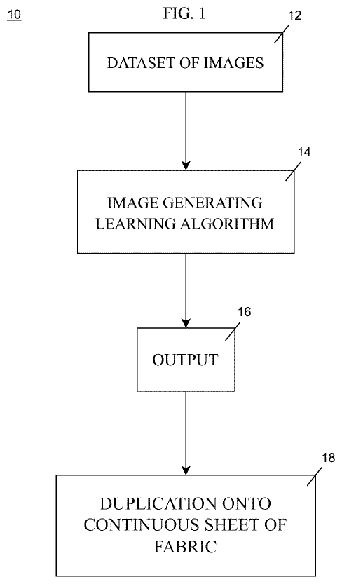

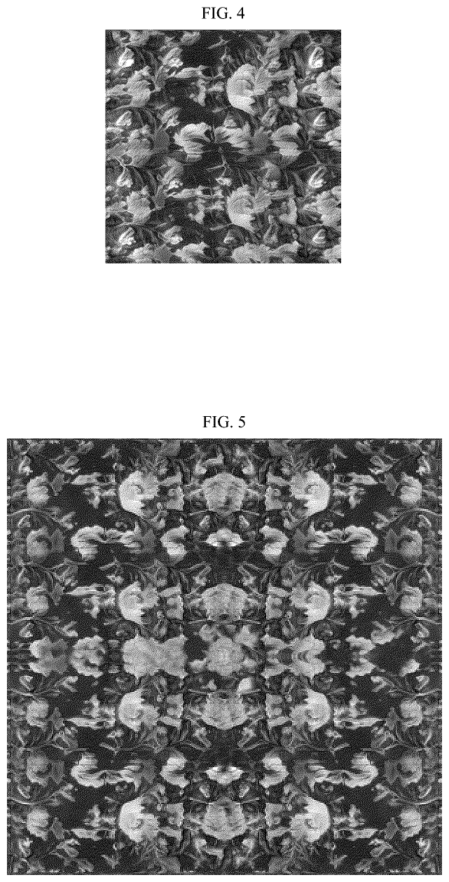

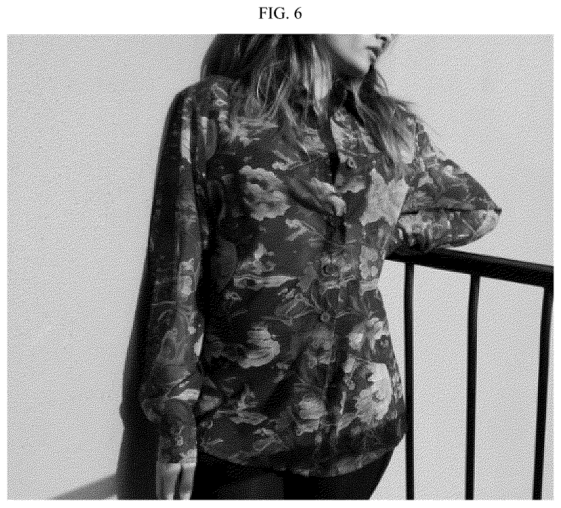

The human mind does not process image creation in the same way as an algorithm. While human creativity can generate various ideas and creations, human creativity is also unclear. On the other hand, algorithms can be primed with a specific dataset in a controlled and predictable manner to build off or work with human creativity. What is presented is a method and system for creating a textile pattern design using AI and printing it on fabric and creating apparel from the fabric. As shown in FIG. 1, the method or system 10 begins by curating a dataset of images 12. The dataset of images 12 is then imported into an image generating learning algorithm 14. The dataset of images 12 can be normalized or not prior to being imported into the image generating learning algorithm 14. By normalization it means that the images can either be edited or formatted to be an input within parameters acceptable to the image generating learning algorithm 14. The image generating learning algorithm 14 can be any applicable ML algorithm such as GANs, CNNs, and other similar ML algorithms. The image generating learning algorithm 14 is then run to produce an output 16, with FIG. 4 being an example of the output 16. The output 16 is received and then duplicated onto a continuous sheet of fabric (duplication onto continuous sheet of fabric 18) and an example of the result is shown in FIG. 5. The sheet of fabric 18 may then be used to create clothing as shown in FIG. 6.

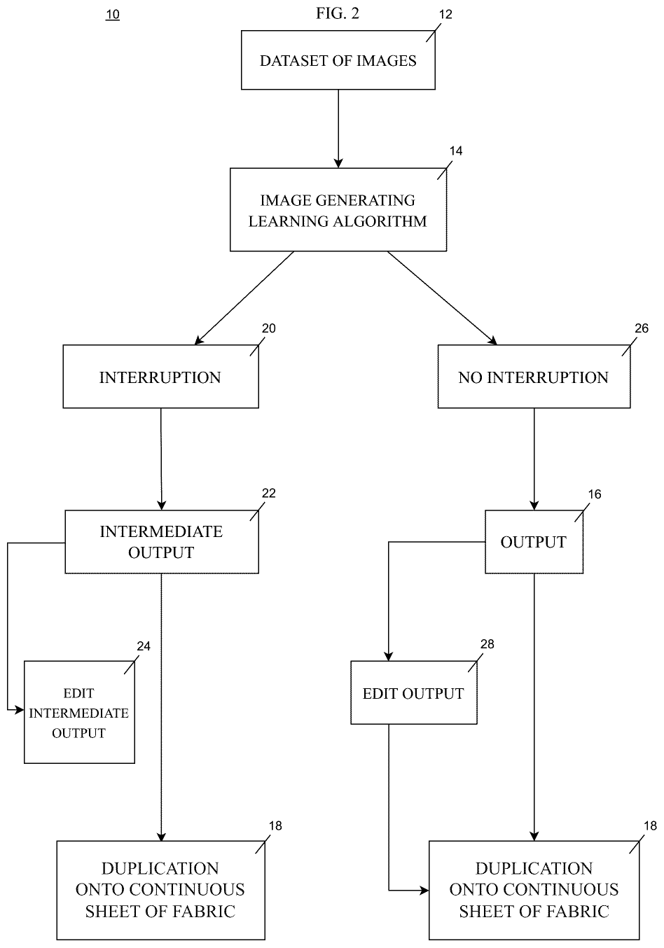

As shown in FIG. 2, the running of the image generating learning algorithm 14 can be interrupted (interruption 20) to receive an intermediate output 22 from the image generating learning algorithm 14. The choice of whether or not to interrupt the image generating learning algorithm 14 is determined by the user of the method or system 10. If the user determines that the method or system 10 has developed a satisfactory output in an intermediate step in the processing of the algorithm, the user may select the intermediate output 22. Sometimes it is necessary to edit intermediate output 24 so that the intermediate output 22 can be a continuous image prior to being duplicated as a continuous image. This is usually uncovered as artifacts at the edges of the output images that do not correspond to patterns on opposite edges of the image. In this instance, the intermediate output 22 is edited to add or remove features that would allow a side-by-side duplication of the image to be a seemingly continuous design (as shown in FIG. 5). This editing is not always required. The continuous sheet of fabric is used for any clothing, curtains, apparel, and other textile creations (as shown for example in FIG. 6).

If the user allows the algorithm to run its course without interruption 26, this results in a fully developed output 16. As with the earlier described process, it is sometimes necessary to edit the output 28 so that the output 16 can be duplicated to form a continuous image. Depending on said need, the output 16 or the edit output 28 is then duplicated onto a continuous sheet of fabric (duplication onto continuous sheet of fabric 18) with an example of the result shown in FIG. 5. The sheet of fabric 18 may then be used to create clothing as shown in FIG. 6.

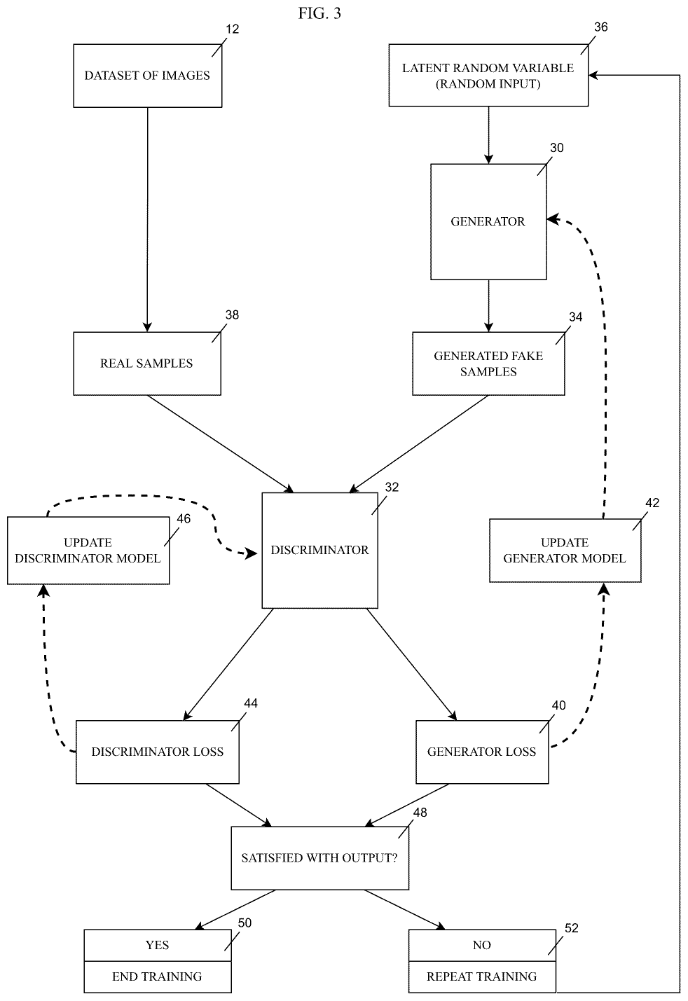

An example of the method or system 10 is using GANs as shown in FIG. 3. A GAN is a ML algorithm designed for unsupervised learning. The algorithm pits two AI sub-models against each other, the generator 30, and the discriminator 32. The generator 30 exists to create generated fake samples 34 and the discriminator 32 exists to determine if images fed to it are real or fake. The dataset of images 12 provided by the user may be normalized into a real sample 38 against which the output from the generator 30 is compared.

For the generator to operate, a latent random variable (random input 36) is imported into the generator 30 to create a generated fake samples 34. As with the dataset of images 12, the random input 36 can be normalized or not. By normalization it means that the images can either be edited or formatted to be an input within parameters acceptable to the image generating learning algorithm 14. The discriminator 32 is randomly fed real samples 38 or generated fake samples 34 to decide if a data point is a generated fake sample 34 from the generator 30 or a real sample 38 from the dataset of images 12. This is why the algorithm is adversarial; the generator 30 is trying to be a trickster and trip up the discriminator 32 in the discriminator's 32 decision-making. The generator 30 wins the GAN game when the discriminator 32 labels a generated fake sample 34 as real. The discriminator 32 wins when it correctly labels a generated fake sample 34 as fake or a real sample as real. GANs are used mainly for image generation.

Upon startup of a GAN, the discriminator 32 alone runs. The dataset of images 12 of the desired output are shown, and the discriminator 32 learns what the output 16 is meant to look like. Then, the generator 30 is kicked on and begins to make generated fake samples 34 of the desired output, and the discriminator 32 is tasked with the increasingly harder job of trying to not get tricked by the generator 30. At this point the algorithm can be unsupervised because the discriminator 32 gets better because the generator 30 is the one feeding it generated fake samples 34, not the human operator.

If the discriminator 32 successfully sniffs out a fake that came from the generator 30, the discriminator 32 remains unchanged, which is a generator loss 40 and an update of the generator model 42 to make better fakes happens. When the discriminator 32 is fooled by the generator 30, the generator 30 remains unchanged, which is a discriminator loss 44 and an update of the discriminator model 46 to better detect fakes in the future happens. The human operator asks if users are satisfied with output 48 or not. If yes, the training ends 50. If no, many iterations with repeat training 52 occur and eventually the generator 30 gets too good, and the discriminator 32 no longer can pick out fakes. Thus, the generator 30 has now created an artificial image of whatever the domain input was set to initially, and the overall ML algorithm has produced a generator 30 that can generate a certain image very well.

By running the algorithm described herein, the image generating learning algorithm 14 generates images and patterns that are informed by the dataset of images 12 but are not any image that was provided to it. In this way a user could, for example, provide a set of images that are of a certain theme in nature, such as flowers, and the image generating learning algorithm 14 could eventually learn to create a pattern that is sufficiently like a flower to fool the AI algorithm into believing it could have been one that was provided by the user. Therefore, the AI creates patterns and designs that never before existed but yet sufficiently resemble the theme of the dataset of images 12. The output of the image generating learning algorithm 14 is based very much on the dataset of images 12 so that for every set of images of a certain theme that are provided, the output could be dramatically different with every full running of the method or system 10 disclosed herein.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A method for creating a textile pattern design, comprising:
curating a dataset of images;
importing the dataset into an image generating learning algorithm;
running the image generating learning algorithm;
receiving an output from the image generating learning algorithm; and
duplicating the output onto a continuous sheet of fabric.

2. The method of claim 1 further comprising normalizing the images in the dataset prior to importing the dataset into the image generating learning algorithm.

3. The method of claim 1 further comprising editing the output from the image generating learning algorithm prior to duplicating the output to enable the duplicated output to be a continuous image.

4. The method of claim 1 further comprising:
interrupting the running of the image generating learning algorithm to receive an intermediate output from the image generating learning algorithm; and
duplicating the intermediate output onto a continuous sheet of fabric.

5. The method of claim 1 further comprising:
interrupting the running of the image generating learning algorithm to receive an intermediate output from the image generating learning algorithm;
editing the intermediate output to enable the intermediate output to be a continuous image; and
duplicating the intermediate output onto a continuous sheet of fabric.

6. The method of claim 1 further comprising the image generating learning algorithm is a Generative Adversarial Network (GAN).

7. The method of claim 1 further comprising the continuous sheet of fabric is used for any of clothing, curtains, apparel, and other textile creations.

8. A system for creating a textile pattern design, comprising:
a curated dataset of images;
an image generating learning algorithm;
running the image generating learning algorithm;
receiving an output from the image generating learning algorithm; and
duplicating the output onto a continuous sheet of fabric.

9. The system of claim 8 further comprising normalizing the images in the dataset prior to importing the dataset into the image generating learning algorithm.

10. The system of claim 8 further comprising editing the output from the image generating learning algorithm prior to duplicating the output.

11. The system of claim 8 further comprising editing the output from the image generating learning algorithm prior to duplicating the output to enable the duplicated output to be a continuous image.

12. The system of claim 8 further comprising:
interrupting the running of the image generating learning algorithm to receive an intermediate output from the image generating learning algorithm; and
duplicating the intermediate output onto a continuous sheet of fabric.

13. The system of claim 8 further comprising:
interrupting the running of the image generating learning algorithm to receive an intermediate output from the image generating learning algorithm;
editing the intermediate output to enable the intermediate output to be a continuous image; and
duplicating the intermediate output onto a continuous sheet of fabric.

14. The system of claim 8 further comprising the image generating learning algorithm is a Generative Adversarial Network (GAN).

15. The system of claim 8 further comprising the continuous sheet of fabric is used for any of clothing, curtains, apparel, and other textile creations.
